(19) United States
(12) Patent Application Publication
(10) Pub. No.: US 2026/0266187 A1
(43) Pub. Date: Sep. 10, 2026

(54) GAS TURBINE ENGINE STATIC VANE CLUSTERS

(71) Applicant: RTX Corporation, Farmington, CT (US)

(72) Inventor: Christian X. Campbell, West Hartford, CT (US)

(21) Appl. No.: 19/664,334

(22) Filed: Apr. 30, 2026

Related U.S. Application Data
(62) Division of application No. 18/070,947, filed on Nov. 29, 2022, now abandoned.

(51) Int. Cl. F01D 9/04

(52) U.S. Cl. CPC F01D 9/044; F01D 9/041; F05D 2230/237; F05D 2240/12; F05D 2300/6033; Y10T 29/49337

(57) ABSTRACT

A multiple static vane component includes a plurality of airfoils each formed of ceramic matrix composite materials. Each of the airfoils are attached to an inner platform and an outer platform both formed of ceramic matrix composite materials. There is a plurality of individual parts forming the plurality of airfoils, the inner platform or the outer platform, bonded to each other with a braze joint. A gas turbine engine and a method are also disclosed.

### CROSS-REFERENCE TO RELATED APPLICATIONS

This application is a divisional of U.S. patent application Ser. No. 18/070,947 filed Nov. 29, 2022.

### BACKGROUND OF THE INVENTION

This application relates to a method of making static vanes for a turbine section in a gas turbine engine, herein there are a cluster of the vanes which are bonded together.

Gas turbine engines are known, and typically include a fan delivering air into a bypass duct as propulsion air. The air is also delivered into a compressor. Compressed air is delivered into a combustor where it is mixed with fuel and ignited. Products of this combustion pass downstream over turbine rotors, driving them to rotate. The turbine rotors in turn drive fan and compressor rotors.

As known, the turbine section sees very high temperatures from the products of combustion. As such, there is an effort made to provide turbine section components that can withstand high temperatures.

One such solution is the use of ceramic matrix composite materials (“CMCs”) for forming turbine section components. CMCs can withstand high temperatures, however, they do raise challenges as to assembly.

Turbine components that may benefit from the use of CMCs include static vanes. There are rows of static vanes axially spaced with rows of turbine blades in a gas turbine engine turbine section.

The rows of turbine vanes can be formed as individual vane, or into a combination of a plurality of vanes.

The prior art has proposed various ways to assemble a plurality of CMC static vanes together. As known, a static vane typically includes an airfoil, an inner platform and an outer platform. The inner and outer platforms typically are each assembled to a plurality of airfoils, such that the platforms are generally continuous as a full hoop.

It has been proposed to form the platforms and airfoils as separate parts and mechanically secure them.

### SUMMARY OF THE INVENTION

In a featured embodiment, a multiple static vane component includes a plurality of airfoils each formed of ceramic matrix composite materials. Each of the airfoils are attached to an inner platform and an outer platform both formed of ceramic matrix composite materials. There is a plurality of individual parts forming the plurality of airfoils, the inner platform or the outer platform, bonded to each other with a braze joint.

In another embodiment according to the previous embodiment, the airfoils are secured to the radially inner and radially outer platforms through the braze joint. The airfoils have an outer frusto-conical surface at both a radially inner end and a radially outer end. The radially outer platform has a boss with an inner frusto-conical surface secured to the frusto-conical surface of the airfoil radially outer surface and the radially inner platform having a boss with an inner frusto-conical surface to be secured to the airfoil radially inner frusto-conical surface through the braze joints.

In another embodiment according to any of the previous embodiments, an inner periphery of the radially inner frusto-conical surface on the airfoil has a greater taper than the inner periphery of the radially outer airfoil frusto-conical surfaces to facilitate removal of a mandrel during assembly.

In another embodiment according to any of the previous embodiments, the radially inner platform and the radially outer platform are provided by a plurality of platform subportions which are connected through the braze joint.

In another embodiment according to any of the previous embodiments, one of the platform subportions has a radially inner undercut step and an adjacent one of the platform subportions has an outer undercut portion with the inner undercut portion of the one of the platform subportions being brazed to the outer undercut portion of the adjacent one of the platform subportions.

In another embodiment according to any of the previous embodiments, one of the platform subportions is secured to another of the platform subportions along ramped surfaces.

In another embodiment according to any of the previous embodiments, an edge of one of the platform subportions and adjacent one of the platform subportions is formed along a curve.

In another embodiment according to any of the previous embodiments, an edge between one of the platform subportions and an adjacent one of the platform subportions is formed along a line.

In another embodiment according to any of the previous embodiments, the platform subportions are formed integrally with an associated one of the plurality of airfoils, with the outer platform of one of the platform subportions secured to an adjacent one of the platform subportions and the inner platform of the one of the platform subportions secured to the adjacent one of the platform subportions by the braze joint.

In another embodiment according to any of the previous embodiments, cooling holes are formed through the radially inner and outer platform adjacent the braze joint.

In another embodiment according to any of the previous embodiments, the airfoils, the radially inner platform and the radially outer platform are all formed of ceramic matrix composites.

In another embodiment according to any of the previous embodiments, the braze material is a silicon based alloy.

In another featured embodiment, a gas turbine engine includes a compressor connected to a combustor. The combustor is connected to a turbine section. The turbine section has a plurality of turbine rows spaced along an axis of rotation of the turbine rotor. There are at least one vane row intermediate axially spaced ones of the turbine blade rows. The at least one vane row has a plurality of airfoils each formed of ceramic matrix composite materials. Each of the airfoils are attached to an inner platform and an outer platform both formed of ceramic matrix composite materials. There is a plurality of individual parts forming the plurality of airfoils, the inner platform or the outer platform, bonded to each other with a braze joint.

In another embodiment according to any of the previous embodiments, the airfoils are secured to the radially inner and radially outer platforms through the braze joint. The airfoils have an outer frusto-conical surface at both a radially inner end and a radially outer end. The radially outer platform has a boss with an inner frusto-conical surface secured to the frusto-conical surface of the airfoil radially outer surface and the radially inner platform having a boss with an inner frusto-conical surface to be secured to the airfoil radially inner frusto-conical surface through the braze joints.

In another embodiment according to any of the previous embodiments, the radially inner platform and the radially outer platform are provided by a plurality of platform subportions which are connected through the braze joint.

In another embodiment according to any of the previous embodiments, the platform subportions are formed integrally with an associated one of the plurality of airfoils, with the outer platform of one of the platform subportions secured to an adjacent one of the platform subportions and the inner platform of the one of the platform subportions secured to the adjacent one of the platform subportions.

In another embodiment according to any of the previous embodiments, the airfoil, the radially inner platform and the radially outer platform are all formed of ceramic matrix composites, and the braze material is a silicon based alloy.

In another featured embodiment, a method of forming a static vane includes the steps of (1) forming an airfoil from ceramic matrix composites having a leading edge and a trailing edge, (2) separately forming an inner and outer platform from ceramic matrix composites, (3) performing at least one of drilling a hole into the airfoil or applying a coating to the airfoil, then (4) brazing the radially inner and outer platforms to the airfoil.

In another embodiment according to any of the previous embodiments, the holes are drilled at both of the leading edge and a trailing edge of the airfoil in step (3).

In another embodiment according to any of the previous embodiments, holes are drilled and the coating is applied prior to step (4).

The present disclosure may include any one or more of the individual features disclosed above and/or below alone or in any combination thereof.

These and other features of the present invention can be best understood from the following specification and drawings, the following of which is a brief description.

### BRIEF DESCRIPTION OF THE DRAWINGS

FIG. 1 shows a gas turbine engine.

FIG. 2A schematically shows a portion of a turbine section.

FIG. 2B schematically shows a static vane assembly.

FIG. 3A shows a portion of a static vane assembly.

FIG. 3B shows the FIG. 3A structure assembled to a plurality of airfoils.

FIG. 3C shows further details of the FIG. 3B embodiment at the outer diameter platform.

FIG. 3D is similar to FIG. 3C, but showing the inner diameter platform.

FIG. 3E shows a detail of a bonded joint between an airfoil and a platform.

FIG. 3F schematically shows a detail of the bond joint.

FIG. 4A shows a detail of forming the airfoil.

FIG. 4B shows a step subsequent to the FIG. 4A step.

FIG. 5A shows an alternative embodiment of a static vane assembly.

FIG. 5B shows a detail of the FIG. 5A embodiment.

FIG. 6 shows an alternative to the FIG. 5A joint.

FIG. 7 shows features that could be incorporated into the FIGS. 5A, 5B and embodiments.

FIG. 8A shows a further embodiment.

FIG. 8B shows another view of the FIG. 8A embodiment.

FIG. 8C is a view along line C-C of FIG. 8B.

FIG. 9 shows a cooling detail that may be incorporated to any of the previous embodiments.

FIG. 10A shows a machining step which may be utilized with any of the FIGS. 3-9 embodiments.

FIG. 10B shows a subsequent step.

### DETAILED DESCRIPTION

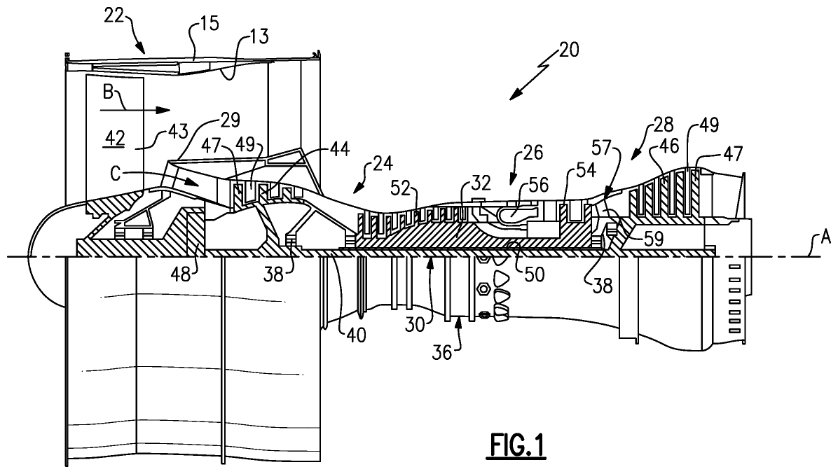

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle, and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. The engine 20 may incorporate a variable area nozzle for varying an exit area of the bypass flow path B and/or a thrust reverser for generating reverse thrust.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The fan 42 may have at least 10 fan blades 43 but no more than 20 or 24 fan blades 43. In examples, the fan 42 may have between 12 and 18 fan blades 43, such as 14 fan blades 43. An exemplary fan size measurement is a maximum radius between the tips of the fan blades 43 and the engine central longitudinal axis A. The maximum radius of the fan blades 43 can be at least 40 inches, or more narrowly no more than 75 inches. For example, the maximum radius of the fan blades 43 can be between 45 inches and 60 inches, such as between 50 inches and 55 inches. Another exemplary fan size measurement is a hub radius, which is defined as distance between a hub of the fan 42 at a location of the leading edges of the fan blades 43 and the engine central longitudinal axis A. The fan blades 43 may establish a fan hub-to-tip ratio, which is defined as a ratio of the hub radius divided by the maximum radius of the fan 42. The fan hub-to-tip ratio can be less than or equal to 0.35, or more narrowly greater than or equal to 0.20, such as between 0.25 and 0.30. The combination of fan blade counts and fan hub-to-tip ratios disclosed herein can provide the engine 20 with a relatively compact fan arrangement.

The low pressure compressor 44, high pressure compressor 52, high pressure turbine 54 and low pressure turbine 46 each include one or more stages having a row of rotatable airfoils. Each stage may include a row of vanes adjacent the rotatable airfoils. The rotatable airfoils are schematically indicated at 47, and the vanes are schematically indicated at 49.

The low pressure compressor 44 and low pressure turbine 46 can include an equal number of stages. For example, the engine 20 can include a three-stage low pressure compressor 44, an eight-stage high pressure compressor 52, a two-stage high pressure turbine 54, and a three-stage low pressure turbine 46 to provide a total of sixteen stages. In other examples, the low pressure compressor 44 includes a different (e.g., greater) number of stages than the low pressure turbine 46. For example, the engine 20 can include a five-stage low pressure compressor 44, a nine-stage high pressure compressor 52, a two-stage high pressure turbine 54, and a four-stage low pressure turbine 46 to provide a total of twenty stages. In other embodiments, the engine 20 includes a four-stage low pressure compressor 44, a nine-stage high pressure compressor 52, a two-stage high pressure turbine 54, and a three-stage low pressure turbine 46 to provide a total of eighteen stages. It should be understood that the engine 20 can incorporate other compressor and turbine stage counts, including any combination of stages disclosed herein.

The engine 20 may be a high-bypass geared aircraft engine. The bypass ratio can be greater than or equal to 10.0 and less than or equal to about 18.0, or more narrowly can be less than or equal to 16.0. The geared architecture 48 may be an epicyclic gear train, such as a planetary gear system or a star gear system. The epicyclic gear train may include a sun gear, a ring gear, a plurality of intermediate gears meshing with the sun gear and ring gear, and a carrier that supports the intermediate gears. The sun gear may provide an input to the gear train. The ring gear (e.g., star gear system) or carrier (e.g., planetary gear system) may provide an output of the gear train to drive the fan 42. A gear reduction ratio may be greater than or equal to 2.3, or more narrowly greater than or equal to 3.0, and in some embodiments the gear reduction ratio is greater than or equal to 3.4. The gear reduction ratio may be less than or equal to 4.0. The fan diameter is significantly larger than that of the low pressure compressor 44. The low pressure turbine 46 can have a pressure ratio that is greater than or equal to 8.0 and in some embodiments is greater than or equal to 10.0. The low pressure turbine pressure ratio can be less than or equal to 13.0, or more narrowly less than or equal to 12.0. Low pressure turbine 46 pressure ratio is pressure measured prior to an inlet of low pressure turbine 46 as related to the pressure at the outlet of the low pressure turbine 46 prior to an exhaust nozzle. It should be understood, however, that the above parameters are only exemplary of one embodiment of a geared architecture engine and that the present invention is applicable to other gas turbine engines including direct drive turbofans. All of these parameters are measured at the cruise condition described below.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. The engine parameters described above, and those in the next paragraph are measured at this condition unless otherwise specified.

“Fan pressure ratio” is the pressure ratio across the fan blade 43 alone, without a Fan Exit Guide Vane (“FEGV”) system. A distance is established in a radial direction between the inner and outer diameters of the bypass duct 13 at an axial position corresponding to a leading edge of the splitter 29 relative to the engine central longitudinal axis A. The fan pressure ratio is a spanwise average of the pressure ratios measured across the fan blade 43 alone over radial positions corresponding to the distance. The fan pressure ratio can be less than or equal to 1.45, or more narrowly greater than or equal to 1.25, such as between 1.30 and 1.40. “Corrected fan tip speed” is the actual fan tip speed in ft/sec divided by an industry standard temperature correction of [(Tram °R)/(518.7 °R)]^{0.5}. The corrected fan tip speed can be less than or equal to 1150.0 ft/second (350.5 meters/second), and can be greater than or equal to 1000.0 ft/second (304.8 meters/second).

The fan 42, low pressure compressor 44 and high pressure compressor 52 can provide different amounts of compression of the incoming airflow that is delivered downstream to the turbine section 28 and cooperate to establish an overall pressure ratio (OPR). The OPR is a product of the fan pressure ratio across a root (i.e., 0% span) of the fan blade 43 alone, a pressure ratio across the low pressure compressor 44 and a pressure ratio across the high pressure compressor 52. The pressure ratio of the low pressure compressor 44 is measured as the pressure at the exit of the low pressure compressor 44 divided by the pressure at the inlet of the low pressure compressor 44. In examples, a sum of the pressure ratio of the low pressure compressor 44 and the fan pressure ratio is between 3.0 and 6.0, or more narrowly is between 4.0 and 5.5. The pressure ratio of the high pressure compressor ratio 52 is measured as the pressure at the exit of the high pressure compressor 52 divided by the pressure at the inlet of the high pressure compressor 52. In examples, the pressure ratio of the high pressure compressor 52 is between 9.0 and 12.0, or more narrowly is between 10.0 and 11.5. The OPR can be equal to or greater than 45.0, and can be less than or equal to 70.0, such as between 50.0 and 60.0. The overall and compressor pressure ratios disclosed herein are measured at the cruise condition described above, and can be utilized in two-spool architectures such as the engine 20 as well as three-spool engine architectures.

The engine 20 establishes a turbine entry temperature (TET). The TET is defined as a maximum temperature of combustion products communicated to an inlet of the turbine section 28 at a maximum takeoff (MTO) condition. The inlet is established at the leading edges of the axially forwardmost row of airfoils of the turbine section 28, and MTO is measured at maximum thrust of the engine 20 at static sea-level and 86 degrees Fahrenheit (° F.). The TET may be greater than or equal to 2700.0° F., or more narrowly less than or equal to 3500.0° F., such as between 2750.0° F. and 3350.0° F. The relatively high TET can be utilized in combination with the other techniques disclosed herein to provide a compact turbine arrangement.

The engine 20 establishes an exhaust gas temperature (EGT). The EGT is defined as a maximum temperature of combustion products in the core flow path C communicated to at the trailing edges of the axially aftmost row of airfoils of the turbine section 28 at the MTO condition. The EGT may be less than or equal to 1000.0° F., or more narrowly greater than or equal to 800.0° F., such as between 900.0° F. and 975.0° F. The relatively low EGT can be utilized in combination with the other techniques disclosed herein to reduce fuel consumption.

FIG. 2A schematically shows a portion of a turbine section 100 such as may be found in a gas turbine engine like that illustrated in FIG. 1.

As known, there are static vanes 102 having an airfoil 104 extending between platforms 106 and 108 axially alternating with rotating turbine blades 110 along an axis of rotation of the turbine blades and the gas turbine engine.

FIG. 2B schematically shows the vanes 102 are actually a plurality of airfoils 104 secured to the inner and outer platforms 106 and 108. The vanes extend circumferentially to create a full hoop about an axis of rotation of the blades 110. In fact, there may be several plural vane parts to cover the entire full hoop. This application is directed to methods of making such a multiple vane component, and in particular when formed from ceramic matrix composites (“CMCs”).

Vanes 102 are formed of CMC material or a monolithic ceramic. A CMC material is comprised of one or more ceramic fiber plies in a ceramic matrix. Example ceramic matrices are silicon-containing ceramic, such as but not limited to, a silicon carbide (SiC) matrix or a silicon nitride (Si3N4) matrix. Example ceramic reinforcement of the CMC are silicon-containing ceramic fibers, such as but not limited to, silicon carbide (SiC) fiber or silicon nitride (Si3N4) fibers. The CMC may be, but is not limited to, a SiC/SiC ceramic matrix composite in which SiC fiber plies are disposed within a SiC matrix. A fiber ply has a fiber architecture, which refers to an ordered arrangement of the fiber tows relative to one another, such as a 2D woven ply or a 3D structure. A monolithic ceramic does not contain fibers or reinforcement and is formed of a single material. Example monolithic ceramics include silicon-containing ceramics, such as silicon carbide (SiC) or silicon nitride (Si3N4).

In embodiments of this disclosure, the airfoil is formed separately from the platforms, and then a bonding process is utilized to connect the components together.

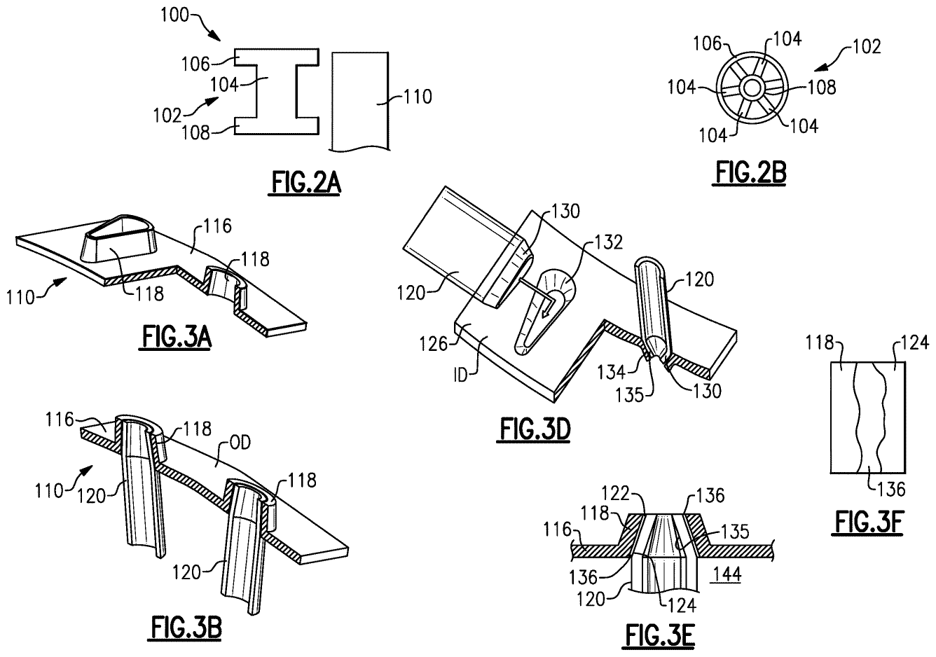

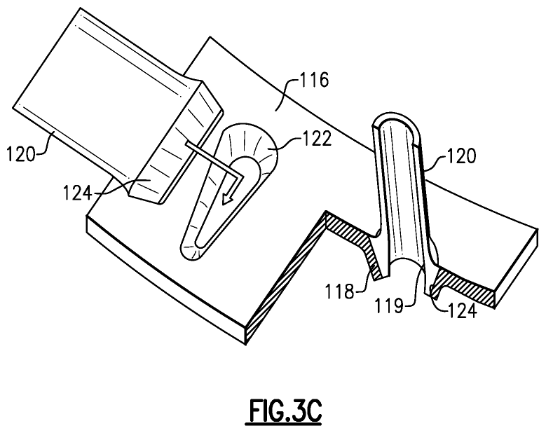

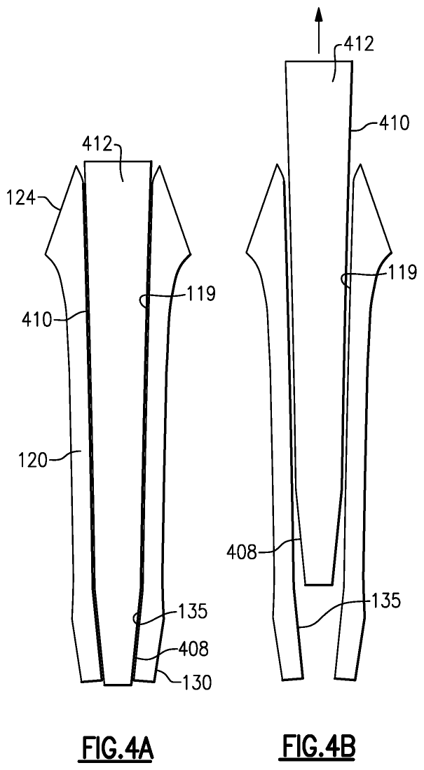

FIG. 3A shows an outer platform 116 having a plurality of raised bosses 118 which will receive airfoils.

FIG. 3B shows the platform 116 secured to airfoils 120 at the enlarged bosses 118.

FIG. 3C shows details of the inner periphery 122 of the enlarged boss 118 on the outer platform 116 which is tapered or frusto-conical and receives a similar frusto-conical shape 124 on the airfoil 120. As can be appreciated from the right hand side of FIG. 3C an inner periphery 119 of the frusto-conical portion 124 of the airfoil 120 is actually formed to be generally cylindrical. The reason for this will be described below.

FIG. 3D shows the inner platform 126 which receives the airfoil 120 having a similar frusto-conical portion 130 received within an inner surface 132 of an enlarged boss 134. Contrary to the inner periphery 119, the airfoil 120 is shown to have the conical portion 130 having an interior surface 135 that is also tapered.

The platforms 126 and 116 are bonded to the airfoil by brazing. The use of the frusto-conical bond surfaces provides a very good surface area to result in a reliable and robust connection. There is a full circle bond surface with a wide contact surface to create a good bond with high load transfer characteristics.

The bonding can occur by applying a compressive force on the two bonding pieces while heat is applied.

FIG. 3E shows the platform 116, the boss 118 and a bond material layer 136 intermediate the surfaces 124 and 122. Bonding techniques such as disclosed in United States Published Patent Application No. US2019/0071364 may be utilized. The disclosure of this prior application is incorporated herein by reference.

The bonding material may be a braze alloy such as a silicon containing alloy. The above-referenced published patent application discloses appropriate materials.

FIG. 3F shows the surfaces 118 and 124 with the intermediate bonding braze material 136 after the bonding operation is complete.

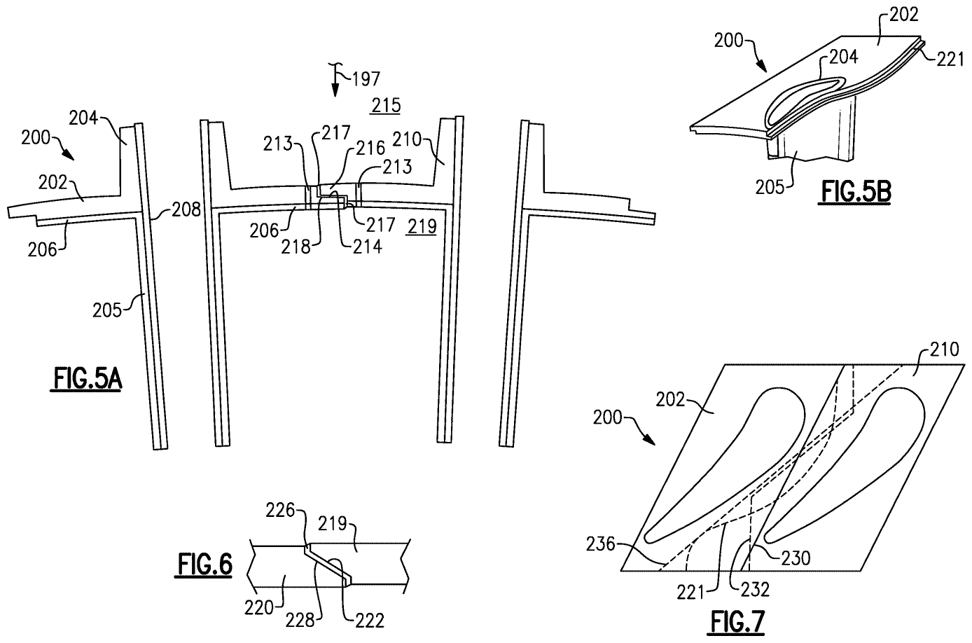

FIG. 4A shows why the inner surface at the inner platform airfoil 120 can be tapered whereas the surface 119 at the outer diameter platform is not as tapered. In forming the airfoil 120, the bond surfaces 124 and 130 may be formed to be tapered or frusto-conical. A mandrel 412 is used as a tool to lay layers of fabric to build the composite preform. The mandrel has a tapered outer periphery 410 and an even more tapered portion 408 and the inner end.

As shown in FIG. 4B, the inner surface 119 is not as tapered as the inner surface 135 so the mandrel 412 can be removed after the airfoil is formed. However, this can also be achieved with a single common taper angle.

FIG. 5A shows an alternative embodiment 200 wherein the platform 202 has the boss 204 which is secured to a shear tube 208 and an airfoil 205 having a platform under surface 206. The platform 202 is secured to an adjacent platform 210 with platform 202 having an inner undercut surface 214 secured to an outer undercut surface 216 of the platform 210. There is a bond layer 218 between the two. The bond layer extends circumferentially along the surface between the undercut 214 and the outer surface 216 and at radially outwardly and inwardly extending portions 217 of the joint. All of these brazed portions extend along an engine axial centerline into and out of the plane of the Figure.

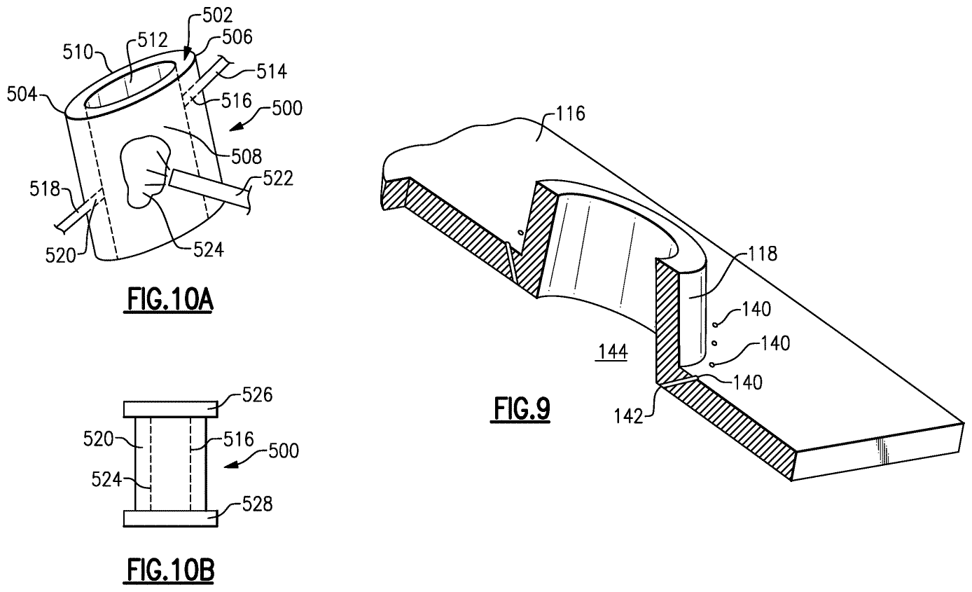

Cooling holes 213 are illustrated schematically, and will be disclosed below with regard to FIG. 9. Cooling air is received within a chamber 215 from a source 197, such as from a heat exchanger receiving compressed air from the compressor section. The provision of cooling air to the area of the joint will protect the joint from hot products of combustion in the chamber 219 which is radially inward of the platforms.

FIG. 5B shows a detail of the embodiment 200 having the platform 202 and the undercut 214. As shown in this Figure the undercut portion 214 and thus the edge of the platform 202 has a radially oriented step.

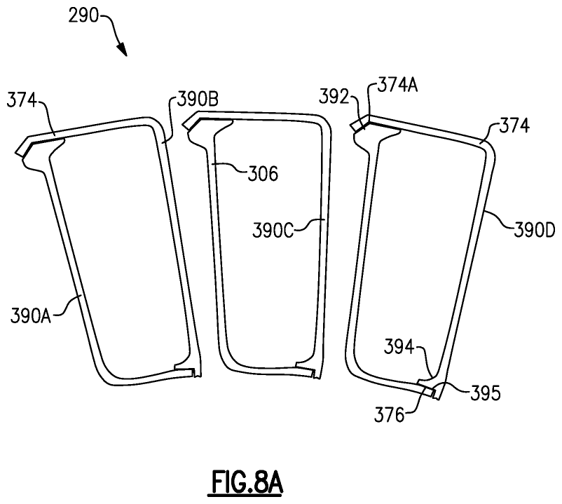

FIG. 6 shows an alternative wherein the undercut of FIG. 5A is replaced with a ramped portion 222 between the platform sections 220 and 219. Here again, a brazed alloy 226 is utilized to provide the connection. As is clear, there is a radially inner step of a radially outer step.

FIG. 7 shows a plurality of options for the connection between the vane platforms 202 and 210. The curved portion 221 of FIG. 5B is illustrated, as are linear portions 230, 232 and 236. The shape of the bond line location can be designed to simplify manufacturing, and to have the bond location at lower stress regions of the platforms.

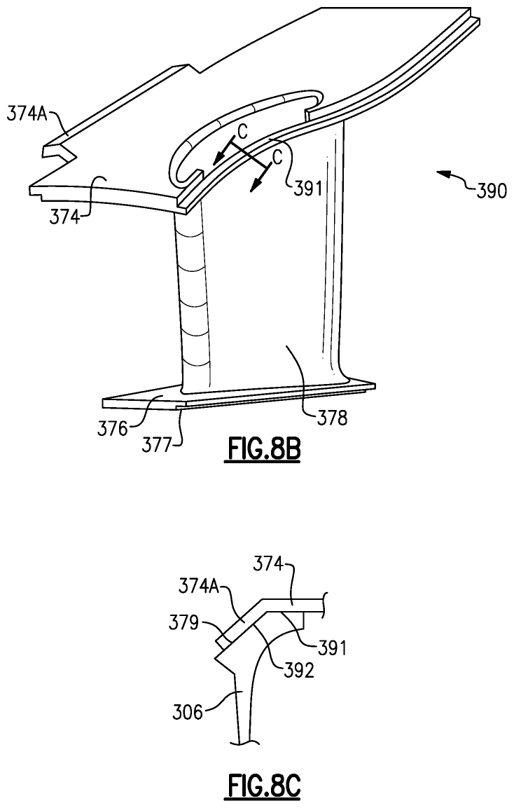

A multipiece vane embodiment 290 is illustrated in FIG. 8A. There are portions of four individual vane segments illustrated as 390A-390D illustrated in this Figure. A platform 374 extends from the vane portion 390D to have a portion 374A bonded to a portion 392 of the adjacent vane section 390C. Further, there is an inner bond joint 395 between an inner platform 376 of the vane subportion 390C and a step 394 on the vane portion 390B.

As shown in FIG. 8B, each of the portions 390A-D include a complete airfoil 378, the inner platform 376 having the step 377 and an outer platform 374 having a tab 374A and step 377 are bonded to adjacent airfoil portion as illustrated in FIG. 8A.

FIG. 8C shows a detail of the bond joint between platform tab 374A and the outer surface 392 and a bond joint 379. An opening 390 is formed to the platform 374 to facilitate receipt of the tab 374A. A portion 391 is cutaway in the platform 374 to allow the tab 374A to move inwardly into the airfoil cavity portion 306. The airfoil sections are secured to two adjacent airfoil sections. The bonding may be by a brazed material as described above. The airfoil sections are formed of CMCs consistent with the above disclosures.

FIG. 9 shows the cooling holes 140 (such as earlier illustrated in FIG. 6). Platform 116 may have its boss 118 provided with a plurality of cooling holes 140 to bring air to an outlet 142 within a chamber 144 that will receive the products of combustion. This will protect the brazed joint.

While the multiple vane components disclosed here are shown having two vanes, combinations having three or more vanes could also benefit from these teachings.

FIG. 10A schematically shows a first step in a method of manufacturing according to this disclosure. Certain manufacturing steps may be best taken on the individual airfoil 500 prior to it being connected to the platforms. Thus, as shown schematically in this Figure, the airfoil 500 has a body 502 with a leading edge 504 and a trailing edge 506.

A cooling channel 512 extends through the airfoil body 502. A first machine 514 is forming cooling ejection holes 516 at the trailing edge 506. Holes 516 are desirably positioned precisely relative to the walls 508 and 510. More precise positioning can be achieved on a standalone airfoil.

A second tool 518 is forming shower head cooling holes 520 at the leading edge 504. The leading edge shower head cooling holes 520 would be difficult to form on an integral vane because the platforms would interfere with the required line of sight axis of a drill head for the tool 518.

A coating machine 522 is providing a coating 524 on each of the suction side and pressure sides 508 and 510. Further, on already assembled vane multiplet components it may be difficult to apply coating to some areas of the vane airfoil. It is easier to apply the coatings prior to bonding to the platforms.

All of these steps may be easier to perform on a standalone airfoil, than on an airfoil already assembled to its platforms.

FIG. 10B shows an assembly step subsequent to that of FIG. 10A. The airfoil 500 has now been secured by bonding operations, as described above, to the platforms 526 and 528. As shown, the holes 520 and 516 as well as the coating 524 have already been formed.

A multiple static vane component under this disclosure could be said to include a plurality of airfoils each formed of ceramic matrix composite materials. Each of the airfoils attached to an inner platform and an outer platform both formed of ceramic matrix composite materials. There are a plurality of individual parts forming a plurality of parts forming the plurality of airfoils, the inner platform or the outer platform, bonded to each other with a braze joint.

A method of forming a static vane under this disclosure could be said to include forming an airfoil from ceramic matrix composites having a leading edge and a trailing edge. Separately forming an inner and outer platform from ceramic matrix composites. Performing at least one of drilling a hole into the airfoil or applying a coating to the airfoil. The radially inner and outer platforms are then brazed to the airfoil.

Although embodiments of this disclosure have been disclosed, a worker of ordinary skill in this art would recognize that modifications would come within the scope of this disclosure. For that reason, the following claims should be studied to determine the true scope and content of this disclosure.

What is claimed is:

1. A multiple static vane component comprising:
a plurality of airfoils each formed of ceramic matrix composite materials, and each of said airfoils attached to an inner platform and an outer platform both formed of ceramic matrix composite materials, and there being a plurality of individual parts forming the plurality of airfoils, the inner platform or the outer platform, bonded to each other with a braze joint.

2. The component as set forth in claim 1, wherein said airfoils being secured to said radially inner and radially outer platforms through the braze joint, and said airfoils having an outer frusto-conical surface at both a radially inner end and a radially outer end, and said radially outer platform having a boss with an inner frusto-conical surface secured to said frusto-conical surface of said airfoil radially outer surface and said radially inner platform having a boss with an inner frusto-conical surface to be secured to said airfoil radially inner frusto-conical surface through the braze joints.

3. The component as set forth in claim 2, wherein an inner periphery of said radially inner frusto-conical surface on said airfoil has a greater taper than the inner periphery of said radially outer airfoil frusto-conical surfaces to facilitate removal of a mandrel during assembly.

4. The component as set forth in claim 1, wherein said radially inner platform and said radially outer platform are provided by a plurality of platform subportions which are connected through the braze joint.

5. The component as set forth in claim 4, wherein one of said platform subportions is secured to another of said platform subportions along ramped surfaces.

6. The component as set forth in claim 4, wherein an edge between one of said platform subportions and an adjacent one of said platform subportions is formed along a line.

7. The component as set forth in claim 1, wherein cooling holes are formed through said radially inner and outer platform adjacent the braze joint.

8. The component as set forth in claim 1, wherein said airfoils, said radially inner platform and said radially outer platform are all formed of ceramic matrix composites.

9. The component as set forth in claim 1, wherein the braze material is a silicon based alloy.

10. A gas turbine engine comprising:
a compressor connected to a combustor, the combustor connected to a turbine section, the turbine section having a plurality of turbine rows spaced along an axis of rotation of the turbine rotor, and there being at least one vane row intermediate axially spaced ones of said turbine blade rows; and
the at least one vane row having a plurality of airfoils each formed of ceramic matrix composite materials, and each of said airfoils attached to an inner platform and an outer platform both formed of ceramic matrix composite materials, and there being a plurality of individual parts forming the plurality of airfoils, the inner platform or the outer platform, bonded to each other with a braze joint.

11. The gas turbine engine as set forth in claim 10, wherein said airfoils being secured to said radially inner and radially outer platforms through the braze joint, and said airfoils having an outer frusto-conical surface at both a radially inner end and a radially outer end, and said radially outer platform having a boss with an inner frusto-conical surface secured to said frusto-conical surface of said airfoil radially outer surface and said radially inner platform having a boss with an inner frusto-conical surface to be secured to said airfoil radially inner frusto-conical surface through the braze joints.

12. The gas turbine engine as set forth in claim 10, wherein said radially inner platform and said radially outer platform are provided by a plurality of platform subportions which are connected through the braze joint.

13. The gas turbine engine as set forth in claim 10, wherein the platform subportions are formed integrally with an associated one of the plurality of airfoils, with said outer platform of one of the platform subportions secured to an adjacent one of the platform subportions and the inner platform of said one of the platform subportions secured to the adjacent one of the platform subportions.

14. The gas turbine engine as set forth in claim 10, wherein said airfoil, said radially inner platform and said radially outer platform are all formed of ceramic matrix composites, and the braze material is a silicon based alloy.

15. A method of forming a static vane comprising the steps of:
(1) forming an airfoil from ceramic matrix composites having a leading edge and a trailing edge;
(2) separately forming an inner and outer platform from ceramic matrix composites; and
(3) performing at least one of drilling a hole into the airfoil or applying a coating to the airfoil;
then (4) brazing the radially inner and outer platforms to the airfoil.

16. The method as set forth in claim 15, wherein the holes are drilled at both of the leading edge and a trailing edge of the airfoil in step (3).

17. The method as set forth in claim 16, wherein holes are drilled and the coating is applied prior to step (4).

18. The method as set forth in claim 15, wherein holes are drilled and the coating is applied prior to step (4).

19. The gas turbine engine as set forth in claim 18, wherein said radially inner platform and said radially outer platform are provided by a plurality of platform subportions which are connected through the braze joint.

20. The gas turbine engine as set forth in claim 15, wherein said radially inner platform and said radially outer platform are provided by a plurality of platform subportions which are connected through the braze joint.
